(19) United States
(12) Patent Application Publication
(10) Pub. No.: US 2011/0164873 A1
(43) Pub. Date: Jul. 7, 2011

(54) OPTICAL REPEATER, OPTICAL TRANSMISSION APPARATUS, REFLECTION ABNORMALITY DETECTION METHOD AND REFLECTION ABNORMALITY RECOVERY DETERMINATION METHOD

(75) Inventors: YUKIO HAYASHI, Yokohama (JP); Kenro Sekine, Fuchu (JP); Chanthan Winh, Yokohama (JP)

(73) Assignee: Hitachi, Ltd.

(21) Appl. No.: 12/983,718

(22) Filed: Jan. 3, 2011

(30) Foreign Application Priority Data
Jan. 5, 2010 (JP) 2010-000599

(51) Int. Cl. H04B 10/08

(52) U.S. Cl. 398/6; 398/18

(57) ABSTRACT

An output light intensity monitor unit of an optical repeater monitors an output light of an output point of the optical repeater. A reflected light intensity monitor unit monitors a reflected light returning from an optical fiber to the output point, An optical fiber transmission line loss from the apparatus output point to an optical fiber open end and a light intensity emitted from the open end are estimated from a monitored reflected light intensity, and a reflection abnormality detection threshold for detecting the reflection abnormality if the light intensity emitted from the open end exceeds a reference light intensity is prescribed. An output light intensity lowering amount and a reflection abnormality recovery threshold are prescribed from an output light intensity monitored at the apparatus output point and the reflected light intensity so that an open end output light intensity may be lowered to the reference light intensity.

### CLAIM OF PRIORITY

The present application claims priority from Japanese patent application JP 2010-000599 filed on Jan. 5, 2010, the contents of which are hereby incorporated by reference into this application.

### BACKGROUND OF THE INVENTION

1. Field of the Invention

The present invention relates to an optical repeater, an optical transmission apparatus, a reflection abnormality detection method and a reflection abnormality recovery determination method, and more particularly to an optical repeater, an optical transmission apparatus, a reflection abnormality detection method and a reflection abnormality recovery determination method having a function of monitoring a reflected light intensity from an optical fiber open end due to breaking of an optical fiber and detecting reflection abnormality, a function of lowering an apparatus output light intensity after detecting the reflection abnormality, and a function of determining recovery from the reflection abnormality, as means for monitoring failure of an optical fiber transmission line.

2. Description of the Related Art

In an optical transmission system, a wavelength multiplexing optical transmission technique of multiplexing a plurality of main signal wavelengths has been introduced, whereby an output light intensity of an optical transmission apparatus has drastically increased. On the other hand, the optical power emitted from an open end face of an optical fiber due to breaking of the optical fiber in an optical transmission line and opening of an optical connector connecting the optical transmission apparatus with the optical fiber transmission line becomes very high output, whereby it is necessary to secure the safety for the human body.

As a related art, there is a function of monitoring a reflected light intensity of a reflected light occurring at the optical fiber open end due to breaking of the optical fiber and releasing of an optical connector and returning to an output point of the optical transmission apparatus, and detecting reflection abnormality and automatically lowering an output light intensity level of the optical transmission apparatus, if a predetermined reflected light intensity or more is detected.

Also, there is a function of automatically returning the output light intensity of the optical transmission apparatus to a required level, if the broken optical fiber or the released optical connector is restored from a reflection abnormality detected state and an output light intensity lowered state of the optical transmission apparatus, and the intensity of reflected light returning from the open end to the optical transmission apparatus is recovered to a prescribed value or lower.

A reflection abnormality detection method of monitoring an absolute quantity of the intensity of reflected light returning from the optical fiber open end to the optical transmission apparatus due to breaking of the optical fiber or releasing of the optical connector, for example, and making a comparative determination of the absolute quantity of the reflected light intensity with a uniquely predetermined reflection abnormality (absolute reflection amount) detection threshold is disclosed in JP-A-6-177837.

Also, another detection method of monitoring both the absolute quantity of the output light intensity and the absolute quantity of the reflected light intensity, calculating a relative reflection amount (=absolute quantity of reflected light intensity/absolute quantity of output light intensity) from a ratio of those absolute quantities, and making a comparative determination with a uniquely predetermined reflection abnormality (relative reflection amount) detection threshold is disclosed in JP-A-4-324335.

Output light intensity lowering methods such as lowering the intensity of output light to be sent from the optical transmission apparatus to the optical fiber transmission line upon detecting the reflection abnormality to a uniquely predetermined output light intensity, and lowering the output light intensity of the optical transmission apparatus to a level substantially equal to an extinction state, for example, are disclosed in JP-A-6-177837 and JP-A-5-83201.

On the other hand, as a reflection abnormality recovery method, like the detection method, a recovery method of monitoring the absolute quantity of the intensity of reflected light returning to the output point of the optical transmission apparatus in the output light intensity lowered state of the optical transmission apparatus, and making a comparative determination with a uniquely predetermined reflection abnormality (absolute reflection amount) recovery threshold, and a recovery method of monitoring both the absolute quantity of the output light intensity and the absolute quantity of the reflection light intensity, calculating the relative reflection amount (=absolute quantity of reflected light/absolute quantity of output light) from the ratio of those absolute quantities, and making a comparative determination with a uniquely predetermined reflection abnormality (relative reflection amount) recovery threshold are disclosed in JP-A-6-177837.

However, with the conventional reflection abnormality detection method, the reflection abnormality detection threshold for determining the reflection abnormality detection is a uniquely predetermined fixed value. On the other hand, the absolute value of the reflected light intensity monitored at the apparatus output point is changed depending on a loss of the optical fiber transmission line itself incurred in the process of the light being reflected at the optical fiber open end face and returning to the apparatus output point, and a loss of an optical component (e.g., optical filter or optical attenuator) inserted between the optical transmission apparatus output point and the optical fiber transmission line, whereby sensitivity of detecting the reflection abnormality is different depending on an open end position of the optical fiber transmission line. For example, as the open end position is closer to the apparatus output point, it is easier to detect the reflection abnormality, and as the open end position is farther from the apparatus output point, it is more difficult to detect the reflection abnormality. That is, the condition of correctly detecting the reflection abnormality is restricted, and the reflection abnormality may not be detected depending on the open end position of the optical fiber transmission line, whereby there is a problem that optical power of high output continues to be emitted from the optical fiber open end face, and the safety for the human body can not be secured. Also, with the conventional output light intensity lowering method, the output light intensity is lowered to the uniquely predetermined fixed level, regardless of the optical fiber open end position, after detecting the reflection abnormality, whereby there is another problem that the absolute quantity of the reflected light intensity monitored at the apparatus output point is remarkably lowered, depending on the open end position, possibly causing a malfunction (false recovery) at the time of making the recovery determination.

Also, with the conventional reflection abnormality recovery method, the reflection abnormality recovery threshold for determining the recovery from the reflection abnormality is the uniquely predetermined fixed value in the same manner as at the time of detecting the reflection abnormality. On the other hand, the absolute quantity of the reflected light intensity monitored at the apparatus output point changes depending on the loss from the apparatus output point to the optical fiber open end, whereby recovery sensitivity is different depending on the optical fiber open end position. For example, as the open end position is closer to the apparatus output point, it is more difficult to recover, and as the open end position is farther from the apparatus output point, it is easier to recover. That is, there is another problem that the reflection amount at the optical fiber open end required for return is different, depending on the open end position, and the recovery determination can not be made at the same level.

### SUMMARY OF THE INVENTION

In the light of the above-mentioned problems, it is an object of the invention to provide an optical repeater, an optical transmission apparatus and a reflection abnormality detection method for detecting reflection abnormality at any optical fiber open end position if an emitted light intensity at an open end exceeds a prescribed value, to prevent continuous emission of high power from an optical fiber open end when an optical fiber transmission line is disconnected. Also, it is another object of the invention to lower an apparatus output light intensity, namely, an open end emitted light intensity. Moreover, it is a further object of the invention to provide an optical repeater, an optical transmission apparatus and a reflection abnormality recovery determination method for determining recovery from an opening of the optical fiber transmission line after the apparatus output light intensity is lowered.

Means for solving the above-mentioned problems will be described below in terms of a reflection abnormality detection section, an output light intensity lowering section and a reflection abnormality recovery section, which are provided for the optical repeater of the invention. In the following description, the means constituting the reflection abnormality detection section, the output light intensity lowering section and the reflection abnormality recovery section may partly overlap.

The reflection abnormality detection section includes output light intensity monitor unit for monitoring an output light intensity of an apparatus output point of sending an input optical signal inputted from an input port to an optical fiber transmission line connected to an output port, reflected light intensity monitor unit for monitoring a reflected light intensity returning from the optical fiber transmission line to the apparatus output point, reflection abnormality detection determination unit for determining reflection abnormality by comparing the reflected light intensity monitored by the reflected light intensity monitor unit with a reflection abnormality detection threshold, and reflection abnormality detection threshold calculation unit for calculating the reflection abnormality detection threshold.

If an optical fiber of the optical fiber transmission line is disconnected, an optical fiber transmission line loss from the apparatus output point to a virtual open end in which a reference light intensity stipulating a maximum value of an open end emitted light intensity emitted from an open end and the open end emitted light intensity are substantially equivalent to each other is estimated from a difference between the output light intensity of the apparatus output point and the reference light intensity, and for a virtual open end emitted light intensity, a reflected light undergoing a certain amount of lowering (hereinafter reflection attenuation amount) at the open end due to Fresnel reflection (reflection occurring on a boundary surface between media having different refractive indexes) is lowered by the estimated optical fiber transmission line loss and returns to the apparatus output point, in which a virtual reflected light intensity observed by the reflected light intensity monitor unit is prescribed as the reflection abnormality detection threshold.

The output light intensity lowering section includes output light intensity lowering amount calculation unit for calculating an output light intensity lowering amount from the output light intensity monitored by the output light intensity monitor unit and the reflected light intensity monitored by the reflected light intensity monitor unit, in addition to the above reflection abnormality detection section.

If the optical fiber of the optical fiber transmission line is disconnected, for a light intensity emitted from a cut-off open end, an optical fiber transmission line loss from the apparatus output point to the open end is estimated from a reflected light intensity in which a reflected light attenuated by the reflection attenuation amount due to the Fresnel reflection returns to the optical transmission apparatus output point and is observed by the reflected light intensity monitor unit, an open end emitted light intensity is estimated from the estimated optical fiber transmission line loss and the apparatus output light intensity, and an amount by which the estimated open end emitted light intensity exceeds the reference level stipulating the maximum value of the light intensity emitted from the open end is prescribed as the output light intensity lowering amount.

The reflection abnormality recovery section includes reflection abnormality recovery threshold calculation unit for calculating a reflection abnormality recovery threshold from the output light intensity lowering amount calculated by the output light intensity lowering amount calculation unit and the reflected light intensity monitored by the reflected light intensity monitor unit, and reflection abnormality recovery determination unit for determining recovery from the reflection abnormality by comparing the reflected light intensity monitored by the reflected light intensity monitor unit with the reflection abnormality recovery threshold, in addition to the reflection abnormality detection section and the output light intensity lowering section.

A virtual reflected light intensity in which the output light intensity lowering amount and a hysteresis amount to provide a hysteresis characteristic in the reflection abnormality detection and recovery process are subtracted from the reflected light intensity at the time of detecting the reflection abnormality is prescribed as the reflection abnormality recovery threshold.

Also, there is provided control unit for managing the state of each functional section based on a determination result of the reflection abnormality detection determination unit, a calculation result of the output light intensity lowering amount calculation unit and a determination result of the reflection abnormality recovery determination unit.

Also, employing output light intensity control unit of wavelength multiplexing optical signal generation unit for multiplexing a plurality of main signal wavelengths to be sent as a unit for lowering the output light intensity, control unit makes an instruction of lowering the output light intensity of the wavelength multiplexing optical signal generation unit, namely, an input light intensity of an input port, to lower the output light intensity lowering amount calculated by the output light intensity lowering amount calculation unit, with an output optical signal of the wavelength multiplexing optical signal generation unit as an input, and notification unit for notifying the instruction to the wavelength multiplexing optical signal generation unit is provided.

Also, as another unit for lowering the output light intensity, signal light intensity control unit is provided, in which an input optical signal is received in the signal light intensity control unit, and the control unit can directly instruct the signal light intensity control unit to lower the output light intensity by the output light intensity lowering amount calculated by the output light intensity lowering amount calculation unit.

According to the first solving means of this invention, there is provided an optical repeater that sends an input optical signal to an optical fiber transmission line connected to an output port, the optical repeater comprising:
an output light intensity monitor unit for monitoring an output light intensity at an apparatus output point;

a reflected light intensity monitor unit for monitoring a reflected light intensity of a reflected light returning from the optical fiber transmission line to the apparatus output point;
a reflection abnormality detection threshold calculation unit for calculating, based on the output light intensity, a reflection abnormality detection threshold for detecting reflection abnormality due to disconnecting or opening of the optical fiber transmission line in a region where a light intensity of an open end emitted light emitted from an open end due to the disconnecting or the opening of the optical fiber transmission line is greater than a predetermined reference light intensity; and
a reflection abnormality detection determination unit for determining detection of the reflection abnormality by comparing the reflected light intensity with the reflection abnormality detection threshold.

According to the first solving means, it is possible to detect reflection abnormality at any optical fiber open end position if an emitted light intensity at an open end exceeds a prescribed value, to prevent continuous emission of high power from an optical fiber open end when an optical fiber transmission line is disconnected.

According to the second solving means of this invention, there is provided an optical repeater that sends an input optical signal to an optical fiber transmission line connected to an output port by controlling a light intensity of the input optical signal, the optical repeater comprising:

an output light intensity monitor unit for monitoring an output light intensity at an apparatus output point;

a reflected light intensity monitor unit for monitoring a reflected light intensity of a reflected light returning from the optical fiber transmission line to the apparatus output point;

a reflection abnormality detection threshold calculation unit for calculating a reflection abnormality detection threshold, based on the output light intensity;

a reflection abnormality detection determination unit for determining detection of reflection abnormality due to disconnecting or opening of the optical fiber transmission line by comparing the reflected light intensity with the reflection abnormality detection threshold;

an output light intensity lowering amount calculation unit for calculating an output light intensity lowering amount based on an estimated emitted light intensity by estimating the emitted light intensity at an open end due to the disconnecting or the opening of the optical fiber transmission line based on the output light intensity and the reflected light intensity; and
a signal light intensity control unit for controlling the output light intensity to be sent to the optical fiber transmission line based on the output light intensity lowering amount calculated by the output light intensity lowering amount calculation unit.

According to the second solving means, it is possible to lower an apparatus output light intensity, namely, an open end emitted light intensity.

According to the third solving means of this invention, there is provided an optical repeater that sends an input optical signal to an optical fiber transmission line connected to an output port by controlling a light intensity of the input optical signal, the optical repeater comprising:

an output light intensity monitor unit for monitoring an output light intensity at an apparatus output point;

a reflected light intensity monitor unit for monitoring a reflected light intensity of a reflected light returning from the optical fiber transmission line to the apparatus output point;

a reflection abnormality detection threshold calculation unit for calculating a reflection abnormality detection threshold, based on the output light intensity;

a reflection abnormality detection determination unit for determining detection of reflection abnormality due to disconnecting or opening of the optical fiber transmission line by comparing the reflected light intensity with the reflection abnormality detection threshold;

an output light intensity lowering amount calculation unit for calculating an output light intensity lowering amount based on the output light intensity and the reflected light intensity;

a signal light intensity control unit for controlling the output light intensity to be sent to the optical fiber transmission line based on the output light intensity lowering amount calculated by the output light intensity lowering amount calculation unit;

a reflection abnormality recovery threshold calculation unit for calculating a reflection abnormality recovery threshold, based on the output light intensity lowering amount and the reflected light intensity when the reflection abnormality is detected, or the reflected light intensity after controlling the output light intensity; and

a reflection abnormality recovery determination unit for determining recovery from the reflection abnormality by comparing the reflected light intensity with the reflection abnormality recovery threshold.

According to the third solving means, it is possible to determine recovery from an opening of the optical fiber transmission line after the apparatus output light intensity is lowered.

According to the fourth solving means of this invention, there is provided an optical transmission apparatus comprising:

the optical repeater described above; and

an optical signal generation unit for generating an optical signal;

wherein the optical repeater inputs the optical signal from the optical signal generation unit.

According to the fifth solving means of this invention, there is provided a reflection abnormality detection method for detecting reflection abnormality of an optical signal in an optical fiber transmission line using an apparatus for sending the input optical signal to the optical fiber transmission line connected to an output port, comprising:

monitoring an output light intensity at an apparatus output point;

monitoring a reflected light intensity of a reflected light returning from the optical fiber transmission line to the apparatus output point;

calculating, based on the output light intensity, a reflection abnormality detection threshold for detecting the reflection abnormality due to disconnecting or opening of the optical fiber transmission line in a region where a light intensity of an open end emitted light emitted from an open end due to the disconnecting or the opening of the optical fiber transmission line is greater than a predetermined reference light intensity; and

determining detection of the reflection abnormality by comparing the reflected light intensity with the reflection abnormality detection threshold.

According to the sixth solving means of this invention, there is provided a reflection abnormality recovery determination method for determining recovery from reflection abnormality in an apparatus for sending an input optical signal to an optical fiber transmission line connected to an output port by controlling a light intensity of the input optical signal and detecting the reflection abnormality of the optical signal in the optical fiber transmission line, comprising:

monitoring an output light intensity at an apparatus output point;

monitoring a reflected light intensity of a reflected light returning from the optical fiber transmission line to the apparatus output point;

calculating an output light intensity lowering amount based on the output light intensity and the reflected light intensity, if the reflection abnormality of the reflected light is detected based on the output light intensity;

controlling the output light intensity to be sent to the optical fiber transmission line based on the output light intensity lowering amount;

calculating a reflection abnormality recovery threshold based on the output light intensity lowering amount and the reflected light intensity when the reflection abnormality is detected, or based on the reflected light intensity after controlling the output light intensity; and

determining recovery from the reflection abnormality by comparing the reflected light intensity with the reflection abnormality recovery threshold.

According to the invention, it is possible to provide an optical repeater, an optical transmission apparatus and a reflection abnormality detection method for detecting reflection abnormality at any optical fiber open end position if an emitted light intensity at an open end exceeds a prescribed value, to prevent continuous emission of high power from an optical fiber open end when an optical fiber transmission line is disconnected. Also, according to the invention, it is possible to lower an apparatus output light intensity, namely, an open end emitted light intensity. Moreover, according to the invention, it is possible to provide an optical repeater, an optical transmission apparatus and a reflection abnormality recovery determination method for determining recovery from an opening of the optical fiber transmission line after the apparatus output light intensity is lowered.

### BRIEF DESCRIPTION OF THE DRAWINGS

FIG. 1 is a block diagram showing the configuration of an optical repeater according to one embodiment of the present invention.

FIG. 2 is a block diagram showing the configuration of the optical repeater according to the embodiment of the invention.

FIG. 3 is a block diagram showing the configuration of the optical repeater according to the embodiment of the invention.

FIG. 4 is a graph showing one example of the relationship between a light intensity in an optical fiber transmission line and an optical fiber transmission line loss to explain the embodiment of the invention.

FIG. 5 is a flowchart showing one example of the cooperative operation of the functions of the optical repeater to explain the embodiment of the invention.

FIG. 6 is a block diagram showing the configuration of an optical repeater according to another embodiment of the invention.

FIG. 7 is a block diagram showing the configuration of the optical repeater according to another embodiment of the invention.

### DETAILED DESCRIPTION OF THE PREFERRED EMBODIMENTS

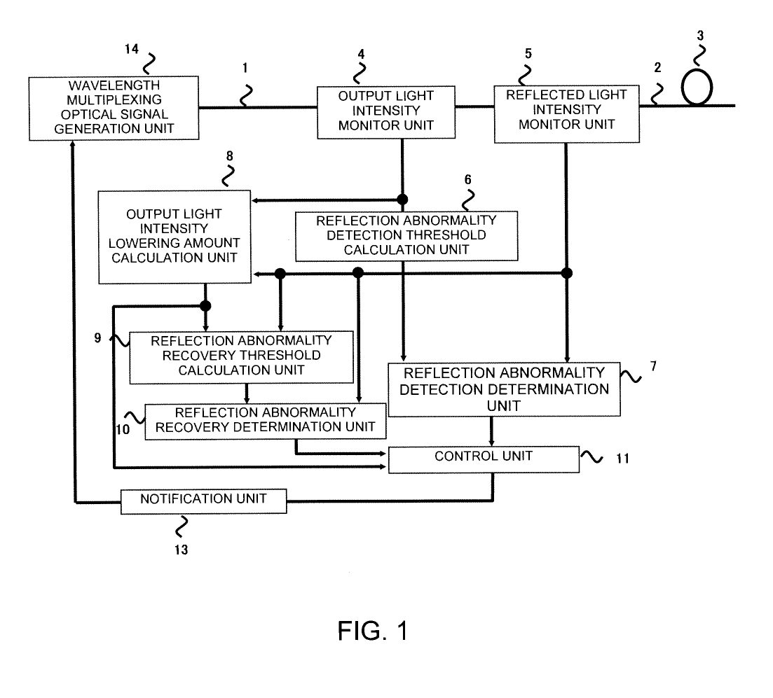

FIG. 1 shows a first configuration example of an optical repeater to fulfill the present invention.

This embodiment will be described below in terms of a reflection abnormality detection section, an output light intensity lowering section and a reflection abnormality recovery section.

The reflection abnormality detection section includes an output light intensity monitor unit 4 for monitoring an output light intensity of an apparatus output point, inputting an output optical signal outputted from a wavelength multiplexing optical signal generation unit 14 into an input port 1 and sending an input optical signal to an optical fiber transmission line 3 connected to an output port 2, a reflected light intensity monitor unit 5 for monitoring a reflected light intensity returning from the optical fiber transmission line 3 to the apparatus output point, a reflection abnormality detection determination unit 7 for determining reflection abnormality by comparing the reflected light intensity monitored by the reflected light intensity monitor unit 5 with a reflection abnormality detection threshold, and a reflection abnormality detection threshold calculation unit 6 for calculating the reflection abnormality detection threshold.

The output light intensity lowering section includes an output light intensity lowering amount calculation unit 8 for calculating an output light intensity lowering amount from the output light intensity monitored by the output light intensity monitor unit 4 and the reflected light intensity monitored by the reflected light intensity monitor unit 5, in addition to the configuration of the reflection abnormality detection section.

The reflection abnormality recovery section includes a reflection abnormality recovery threshold calculation unit 9 for calculating a reflection abnormality recovery threshold from the output light intensity lowering amount calculated by the output light intensity lowering amount calculation unit 8 and the reflected light intensity monitored by the reflected light intensity monitor unit 5, and a reflection abnormality recovery determination unit 10 for determining recovery from the reflection abnormality by comparing the reflected light intensity monitored by the reflected light intensity monitor unit 5 with the reflection abnormality recovery threshold, in addition to the configuration of the reflection abnormality detection section and the configuration of the output light intensity lowering section.

A control unit 11 inputs a determination result of the reflection abnormality detection determination unit 7, a calculation result of the output light intensity lowering amount calculation unit 8 and a determination result of the reflection abnormality recovery determination unit 10. A notification unit 13 notifies the output light intensity lowering amount to the wavelength multiplexing optical signal generation unit 14.

Using an output light intensity control unit of the wavelength multiplexing optical signal generation unit 14 as a unit for lowering the output light intensity, the control unit 11 makes an instruction of lowering the output light intensity of the wavelength multiplexing optical signal generation unit 14, namely, an input light intensity of the input port 1 by the output light intensity lowering amount calculated by the output light intensity lowering amount calculation unit 8, and the notification unit 13 passes the instruction to the wavelength multiplexing optical signal generation unit 14.

In this embodiment, it is unnecessary to directly provide the unit for lowering the output light intensity, but it is possible to substantially lower the output light intensity in cooperation with an apparatus having a unit for controlling the lowering of the input light intensity by a designated lowering amount, which is equivalent to substantially lowering the output light intensity.

Apart except for the wavelength multiplexing optical signal generation unit 14 in FIG. 1 is called an optical repeater, and a combination of the optical repeater and the wavelength multiplexing optical signal generation unit 14 is often called an optical transmission apparatus.

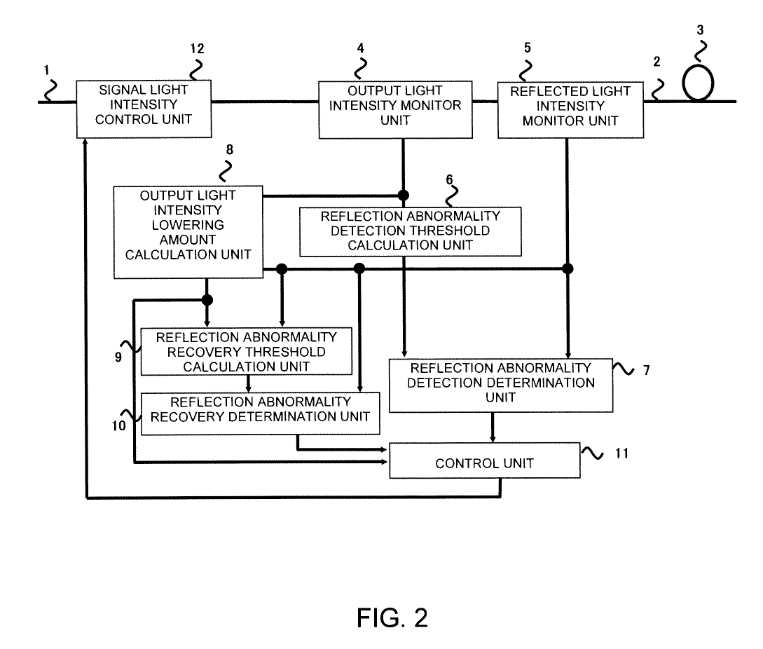

FIG. 2 shows a second configuration example of the optical repeater to fulfill the invention.

In this configuration example, there is provided a signal light intensity control unit 12 that receives the input optical signal, and the control unit 11 can directly make an instruction to the signal light intensity control unit 12 to lower the output light intensity by the output light intensity lowering amount calculated by the output light intensity lowering amount calculation unit 8.

In this configuration example, there is provided the signal light intensity control unit 12, in addition to the first configuration example as shown in FIG. 1, and accordingly, it is unnecessary to control the output light intensity of the wavelength multiplexing optical signal generation unit 14, and to provide the notification unit 13 for passing the output light intensity lowering amount to the wavelength multiplexing optical signal generation unit 14. Also, since the output light intensity lowering amount can be directly instructed from the control unit 11, this configuration example is suitable for the uses of lowering the output light intensity as quickly as possible, after detecting the reflection abnormality, for example.

In the optical repeater as shown in FIGS. 1 and 2, the reflection abnormality detection threshold, the output light intensity lowering amount and the reflection abnormality recovery threshold that are calculated by the reflection abnormality detection threshold calculation unit 6, the output light intensity lowering amount calculation unit 8 and the reflection abnormality recovery threshold calculation unit 9 are prescribed as follows.

The reflection abnormality detection threshold will be described below. When the optical fiber in the optical fiber transmission line is disconnected, an intensity of output light outputted from the apparatus undergoes an optical fiber transmission line loss whereby a point at which a reference light intensity stipulating a maximum value (permissible maximum value) of an open end emitted light intensity emitted from an open end, and the open end emitted light intensity are substantially equivalent is defined as a virtual open end. The reference light intensity is prescribed at a level where an optical power emitted from a disconnected position has no influence on the human body, for example. The optical fiber transmission line loss from an apparatus output point to the virtual open end is estimated from the difference between the output light intensity of the apparatus output point and the reference light intensity. For the virtual emitted light intensity at the virtual open end, a reflected light undergoing a certain amount of lowering (hereinafter reflection attenuation amount) due to Fresnel reflection (reflection occurring on a boundary surface between media having different refractive indexes) is lowered by the estimated optical fiber transmission line loss and returns to the apparatus output point. This is observed by the reflected light intensity monitor unit, and an observed virtual reflected light intensity is prescribed as the reflection abnormality detection threshold.

Next, the output light intensity lowering amount will be described below. The optical fiber in the optical fiber transmission line is disconnected, the reflected light attenuated by the reflection attenuation amount due to the Fresnel reflection from the light intensity emitted from the disconnected open end returns to the optical transmission apparatus output point, and the reflected light intensity is observed by the reflected light intensity monitor unit. The optical fiber transmission line loss from the apparatus output point to the open end is estimated from the observed reflected light intensity, and the open end emitted light intensity is estimated from the estimated optical fiber transmission line loss and the apparatus output light intensity, in which an amount by which the estimated open end emitted light intensity exceeds the reference light intensity stipulating the maximum value of the light intensity emitted from the open end is prescribed as the output light intensity lowering amount.

The reflection abnormality recovery threshold is prescribed as a virtual reflected light intensity in which the output light intensity lowering amount and a hysteresis amount for providing a hysteresis characteristic in the reflection abnormality detection and recovery process are subtracted from the reflected light intensity at the time of detecting the reflection abnormality.

A way of prescribing each of the above thresholds will be described below using the drawings.

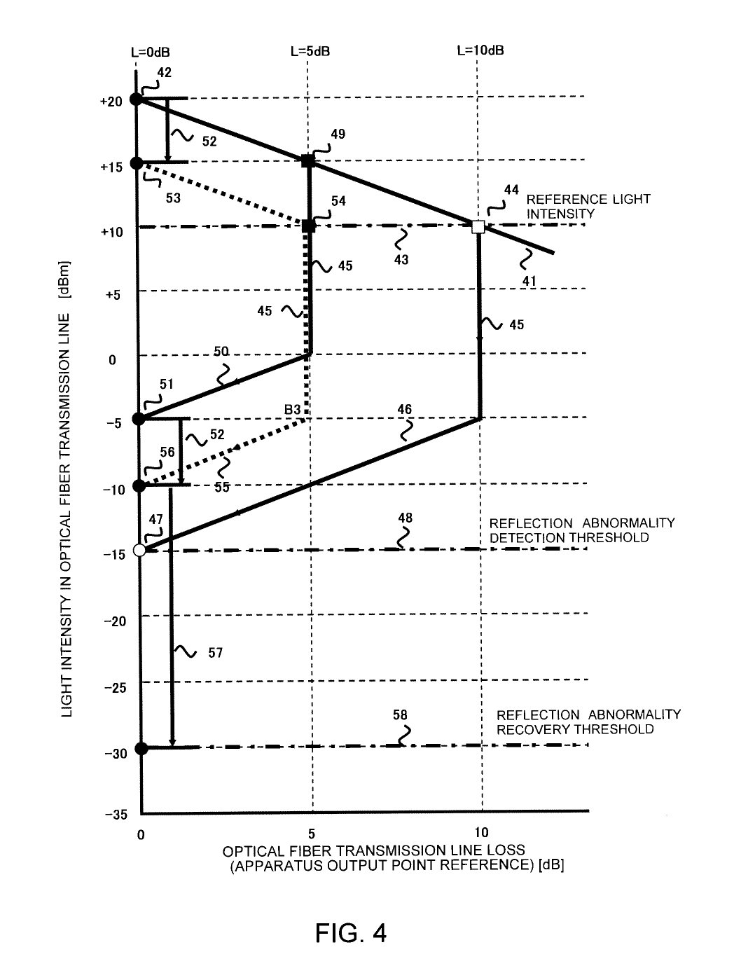

FIG. 4 is an explanatory view for explaining how to prescribe the reflection abnormality detection threshold, the output light intensity lowering amount and the reflection abnormality recovery threshold according to this embodiment. FIG. 4 shows one example of the relationship between the light intensity in the optical fiber transmission line 3 and the optical fiber transmission line loss. In the example of FIG. 4, when the apparatus output light intensity=+20 dBm, the reference light intensity=+10 dBm and the reflection attenuation amount at the open end=15 dB, the optical fiber end face is opened at the position where a transmission line loss L=5 dB.

The light intensity (before output lowering) in the optical fiber transmission line is lowered along with the optical fiber transmission line loss, as shown in a light intensity level diagram 41 in the optical fiber transmission line in the normal time. A point of the optical fiber transmission line loss=0 dB corresponds to the light intensity of the apparatus output point.

In the optical intensity level diagram 41 in the optical fiber transmission line in the normal time, it is assumed that the optical fiber end face is opened at a point of loss (L=10 dB) where the light intensity in the optical fiber transmission line and a reference light intensity 43 are equal.

The reflected light occurring due to the Fresnel reflection at the virtual open end is lowered by an open end reflection attenuation amount 45 (=15 dB) from a virtual open end emitted light intensity 44, undergoes the loss of the optical fiber transmission line, and returns to the apparatus output point. At this time, a reflected light intensity 47 (−15 dBm) observed at the apparatus output point is prescribed as a reflection abnormality detection threshold 48. A light intensity level diagram 46 of the reflected light occurring at the virtual open end is shown.

Next, a unit for prescribing the output light intensity lowering amount and the reflection abnormality recovery threshold will be described below, taking an example where the optical fiber end face is opened at the position of the optical fiber transmission line loss L=5 dB in the light intensity level diagram 41 in the optical fiber transmission line in the normal time.

In the case where the optical fiber end face is opened at the position of the optical fiber transmission line loss L=5 dB, the reflected light occurring due to the Fresnel reflection at the open end is lowered by the open end reflection attenuation amount 45 (=15 dB) from an open end emitted light intensity 49, undergoes the optical fiber transmission line loss, and returns to the apparatus output point. This reflected light is observed as a reflected light intensity 51 (=−5 dBm) with L=5 dB at the open end by the reflected light intensity monitor unit 5. A reflected light intensity level diagram 50 before the apparatus output light intensity is lowered with L=5 dB at the open end is shown.

At this time, the observed reflected light intensity 51 exceeds the reflection abnormality detection threshold 48, whereby the reflection abnormality is determined.

The optical fiber transmission line loss from the apparatus output point to a point of the optical fiber open end is estimated, based on the reflected light intensity 51 (=−5 dBm) with L=5 dB at the open end, and the open end emitted light intensity 49 is calculated. For example, subtracting the open end reflection attenuation amount 45 from the difference between an apparatus output light intensity 42 observed by the output light intensity monitor unit 4 and the reflected light intensity 51 observed by the reflected light intensity monitor unit 5, the optical fiber transmission line loss for both ways between the apparatus output point and the open end is obtained. Dividing it by 2, the optical fiber transmission line loss from the apparatus output point to the point of the optical fiber open end is estimated, and the open end emitted light intensity 49 is calculated from the apparatus output light intensity 42 and the estimated optical fiber transmission line loss. An apparatus output light intensity lowering amount 52 (ΔP=5 dB) is calculated from the difference (excess amount) between the open end emitted light intensity 49 and the reference light intensity 43 to lower the apparatus output light intensity.

After the apparatus output light intensity is lowered, an open end emitted light intensity 54 is equal to the reference light intensity 43, and a reflected light intensity 56 returning from the open end to the apparatus output point is also lowered. A reflected light intensity level diagram 55 after the apparatus output light intensity is lowered with L=5 dB at the open end is shown. Herein, the reflected light intensity 56 observed by the reflected light intensity monitor unit 5 is greater than the reflection abnormality detection threshold, but the light intensity emitted from the open end is suppressed to the reference light intensity or lower.

Next, a value in which the output light intensity lowering amount 52 and a predetermined hysteresis amount 57 are subtracted from the reflected light intensity 51 returning to the apparatus output point before lowering the apparatus output light intensity is prescribed as a reflection abnormality recovery threshold 58. Herein, it was assumed that the reflection attenuation amount of the open end face to determine the recovery from the reflection abnormality is 35 dB and the hysteresis amount is 20 dB.

An output light intensity lowered state is kept until the reflected light intensity falls below the recovery threshold, and if the reflected light intensity falls below the recovery threshold, reflection abnormality recovery is determined, in which the apparatus output light intensity is returned to a predetermined level 20.

Next, a calculation process for the reflection abnormality detection threshold, the output light intensity lowering amount and the reflection abnormality recovery threshold will be described below using the following formulae. Herein, it is assumed that the output light intensity observed at the apparatus output point is Pout (dBm), the observed reflected light intensity is Pref (dBm), the reference light intensity is Psafe (dBm), the optical fiber transmission line loss from the apparatus output point to the optical fiber open end is L (dB), the reflection attenuation amount due to the Fresnel reflection at the open end is R (dB), the hysteresis amount for the recovery determination is α(dB), and the optical fiber open end emitted light intensity is Popen (dBm).

The reflection abnormality detection threshold is calculated based on the formulae (1) to (4).

The reflected light intensity is indicated from the apparatus output light intensity and the optical fiber transmission line loss up to the optical fiber open end in the following formula.

Pref(dBm)=Pout (dBm)−2×L(dB)−R(dB) (1)

Also, the optical fiber open end emitted light intensity is indicated in the following formula (corresponding to 49 in FIG. 4).

Popen (dBm)=Pout (dBm)−L(dB) (2)

Herein an optical fiber transmission line loss Lsafe (dB) at a point where the open end emitted light intensity and a safety level regulated power are equal is estimated in the following formula.

Lsafe (dB)=Pout (dBm)−Psafe (dBm) (3)

Accordingly, a detection threshold Pdet for determining the reflection abnormality in the reflected light intensity is prescribed as a value indicated in the following formula (corresponding to the diagram 41 in FIG. 4).

Pdet(dBm)=Pout (dBm)−2×Lsafe (dB)−R(dB)=2×Psafe (dBm)−Pout (dBm)−R(dB) (4)

The reference light intensity Psafe and the reflection attenuation amount R can be predetermined. The output light intensity Pout is observed by the output light intensity monitor unit 4. The reflection abnormality detection threshold calculation unit 6 can obtain the reflection abnormality detection threshold Pdet, using these values, based on the formula (4).

The output light intensity lowering amount is calculated based on the following formulae (5) to (7).

An amount by which the safety level is exceeded at the optical fiber open end is obtained from the reflected light intensity, and the excess amount is prescribed as the output light intensity lowering amount. From the formula (1), the optical transmission line loss L up to the optical fiber open end is estimated from the reflected light intensity Pref and the apparatus output light intensity Pout at the time of detecting the reflection abnormality in the following formula.

L(dB)=½×{Pout (dBm)−Pref(dBm)−R(dB)} (5)

Also, from the formula (2), the open end emitted light intensity is indicated in the following formula.

Popen (dBm)=Pout (dBm)−L(dB)=½×{Pout (dBm)+Pref(dBm)+R(dB)} (6)

Where Pref (dBm) is a reflection monitor value at the time of detecting the reflection abnormality (before lowering the output light intensity).

From the formula (6), an output light intensity lowering amount ΔPout corresponding to the amount by which the open end emitted light intensity exceeds the safety level is prescribed in the following formula.

ΔPout (dB)=½(Pout (dBm)+Pref(dBm)+R(dB))−Psafe (dBm) (7)

The reflection abnormality recovery threshold is calculated based on the formulae (8) to (10).

The recovery threshold is prescribed as a value in which the output light intensity lowering amount and the hysteresis amount are subtracted from the reflected light intensity at the time of detecting the reflection abnormality. Accordingly, from the formulae (1) and (7), the recovery threshold is prescribed in the following formula.

Prec(dBm)=Pref(dBm)−ΔPout (dB)−α(dB)=½×(Pref(dBm)−Pout (dBm)−R(dB))−α(dB) (8)

The recovery threshold may be obtained by subtracting the hysteresis amount α from the reflected light intensity after lowering the output light.

Herein, the hysteresis amount α is chosen so that the following formula may hold to judge the recovery from the reflection abnormality in the case where the reflection attenuation amount at the open end face is improved from R (dB) to X (dB).

α(dB)≦X(dB)−R(dB) (9)

Also, in the recovery from the reflection abnormality in the case where the reflection attenuation amount at the open end face is improved from R (dB) to X (dB), the reflection abnormality and the recovery are repeated if the reflected light intensity exceeds the reflection abnormality detection threshold as indicated in the formula (4), whereby it is necessary to choose X (dB) so that the following formula may hold.

Pout (dBm)−Pdet(dBm)≦X(dB) (10)

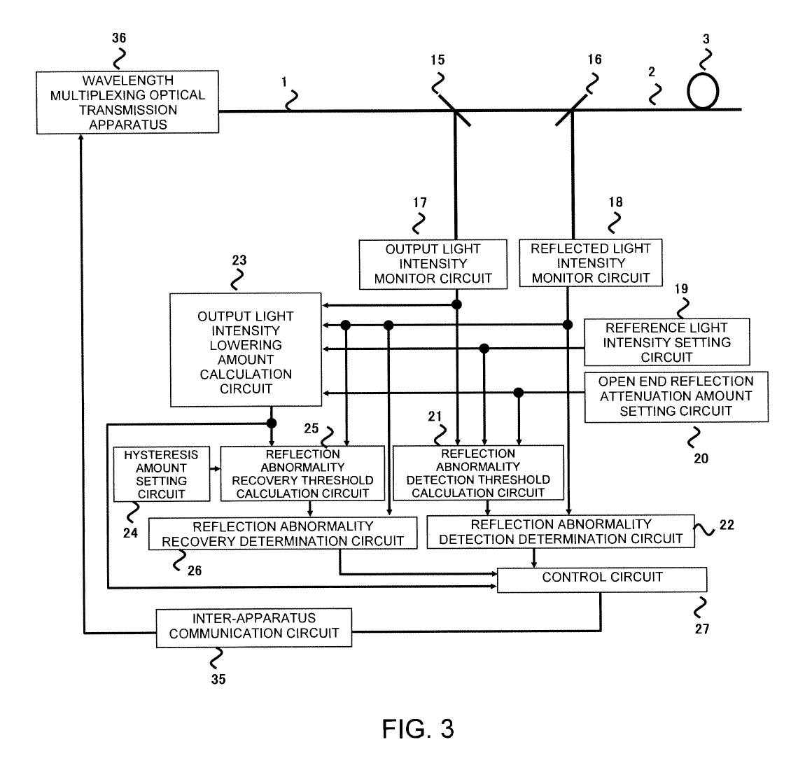

FIG. 3 shows a third configuration example of the optical repeater to fulfill the invention.

In the example as shown in FIG. 3, the optical repeater composed of each unit as shown in FIG. 1 is more specifically shown.

The optical repeater includes an output light branching optical coupler 15, a reflected light branching optical coupler 16, an output light intensity monitor circuit 17, a reflected light intensity monitor circuit 18, a reference light intensity setting circuit 19, an open end reflection attenuation amount setting circuit 20, a reflection abnormality detection threshold calculation circuit 21, a reflection abnormality detection determination circuit 22, an output light intensity lowering amount calculation circuit 23, a hysteresis amount setting circuit 24, a reflection abnormality recovery threshold calculation circuit 25, a reflection abnormality recovery determination circuit 26, and a control circuit 27. Also, it further includes an inter-apparatus communication circuit 35 for communicating with a wavelength multiplexing optical transmission apparatus 36.

The configurations of a light intensity monitor section, a reflection abnormality detection section, an output light intensity lowering section, a reflection abnormality recovery section, and a control section will be described below.

In the light intensity monitor section, the output light branching optical coupler 15 and the reflected light branching optical coupler 16 are inserted between the input port 1 and the output port 2 in a path where the output optical signal outputted from the wavelength multiplexing optical transmission apparatus 36 is inputted into the input port 1 and the input optical signal of the input port 1 is outputted to the output port 2 connected to the optical fiber transmission line 3. It further includes the output light intensity monitor circuit 17 for monitoring the output light intensity of the apparatus output point to be sent to the optical fiber transmission line with the signal light branched by the output light branching optical coupler 15 as the input, and the reflected light intensity monitor circuit 18 for monitoring the reflected light intensity returning from the optical fiber transmission line to the apparatus output point with the reflected light branched by the reflected light branching optical coupler 16 as the input.

For the signal intensity outputted from the output light intensity monitor circuit 17 and the reflected light intensity monitor circuit 18 to correspond to the light intensity, the output signal of the light intensity monitor circuit is converted into dBm that is the unit of light intensity in the following.

The reflection abnormality detection section includes the reflected light intensity monitor circuit 18, the reference light intensity setting circuit 19 for setting the reference light intensity stipulating the maximum value (permissible value) of light intensity emitted from the optical fiber open end when the optical fiber transmission line 3 is disconnected, the open end reflection attenuation amount setting circuit 20 for setting the reflection attenuation amount indicating the percentage of the open end emitted light intensity returning as the reflected light due to the Fresnel reflection occurring at the optical fiber open end, the reflection abnormality detection threshold calculation circuit 21 for calculating the reflection abnormality detection threshold from a reference light intensity signal outputted from the reference light intensity setting circuit 19, a reflection attenuation amount setting signal outputted from the open end reflection attenuation amount setting circuit 20 and an output light intensity signal outputted from the output light intensity monitor circuit 17, and the reflection abnormality detection determination circuit 22 for determining the reflection abnormality detection from the reflection abnormality detection threshold calculated in the reflection abnormality detection threshold calculation circuit 21 and the reflected light intensity outputted from the reflected light intensity monitor circuit 18.

The reflection abnormality detection threshold calculation circuit 21 calculates the optical fiber transmission line loss L (dB) (=Pout−Psafe) from the apparatus output point to the open end in which the light intensity emitted from the open end is equal to the reference light intensity according to the output light intensity signal Pout (dBm) and the reference light intensity signal Psafe (dBm). Then, it calculates the reflected light intensity (=2×Psafe−Pout−R: formula (4)) returning to the output point due to the Fresnel reflection at the open end (virtual open end) at which the light intensity emitted from the open end is equal to the reference light intensity from the reference light intensity signal Psafe (dBm), the reflection attenuation amount signal R (dB) set by the open end reflection attenuation amount setting circuit 20 and the L (dB) obtained previously, and outputs the calculated value as the reflection abnormality detection threshold.

The reflection abnormality detection determination circuit 22 determines the presence or absence of reflection abnormality detection by comparing the reflected light intensity outputted from the reflected light intensity monitor circuit 18 with the reflection abnormality detection threshold calculated in the reflection abnormality detection threshold calculation circuit 21 and notifies a result to the control circuit 27.

The output light intensity lowering section includes the output light intensity monitor circuit 17, the reflected light intensity monitor circuit 18, the reference light intensity setting circuit 19 for setting the reference light intensity stipulating the maximum value of light intensity emitted from the optical fiber open end, the reflection attenuation amount setting circuit 20 for setting the reflection attenuation amount indicating the percentage of the open end emitted light intensity returning as the reflected light due to the Fresnel reflection occurring at the optical fiber open end, the output light intensity lowering amount calculation circuit 23 for calculating the output light intensity lowering amount from the output light intensity signal outputted from the output light intensity monitor circuit 17, a reflected light intensity signal outputted from the reflected light intensity monitor circuit 18, the reference light intensity signal outputted from the reference light intensity setting circuit 19, and the reflection attenuation amount setting signal outputted from the open end reflection attenuation amount setting circuit 20, and the inter-apparatus communication circuit 35 for notifying the wavelength multiplexing optical transmission apparatus that the output light intensity lowering amount calculated in the output light intensity lowering amount calculation circuit 23 is to be lowered.

The output light intensity lowering amount calculation circuit 23 calculates the optical fiber transmission line loss L (dB)(=½×(Pout−Pref−R): formula (5)) up to the open end from the output light intensity signal Pout (dBm), the reflected light intensity signal Pref (dBm) at the time of detecting the reflection abnormality in the reflection abnormality detection function, the reflection attenuation amount R (dB), and the reference light intensity signal Psafe (dBm). Then, it calculates the light intensity Popen (dBm) emitted from the open end by subtracting the optical fiber transmission line loss L (dB) up to the open end from the output light intensity signal Pout (dBm), and the difference ΔP (dB) (=Popen−Psafe) between the light intensity Popen (dBm) and the reference light intensity Psafe (dBm), and outputs the difference as the output light intensity lowering amount. Using the output light intensity control unit of the wavelength multiplexing optical transmission apparatus 36, the control unit 27 makes an instruction of lowering the output light intensity of the wavelength multiplexing optical transmission apparatus 36, namely, the input light intensity of the input port 1, by the output light intensity lowering amount calculated in the output light intensity lowering amount calculation circuit 23, and the inter-apparatus communication circuit 35 passes the instruction to the wavelength multiplexing optical transmission apparatus 36 to lower the output light intensity.

Also, in the reflection abnormality detection function, if no reflection abnormality is detected, it is unnecessary to lower the output light intensity, and a result with the output light intensity lowering amount ΔP=0 (dB) is outputted from the output light intensity lowering amount calculation circuit 23.

The reflection abnormality recovery determination section includes the reflected light intensity monitor circuit 18, the hysteresis amount setting circuit 24, the reflection abnormality recovery threshold calculation circuit 25 for calculating the reflection abnormality recovery threshold from an output light intensity lowering amount signal outputted from the output light intensity lowering amount calculation circuit 23, the reflected light intensity signal outputted from the reflected light intensity monitor circuit 18, and a hysteresis amount setting signal outputted from the hysteresis amount setting circuit 24, and the reflection abnormality recovery determination circuit 26 for determining the reflection abnormality recovery from the reflection abnormality recovery threshold calculated in the reflection abnormality recovery threshold calculation circuit 25 and the reflected light intensity outputted from the reflected light intensity monitor circuit 18.

The reflection abnormality recovery threshold calculation circuit 25 holds the reflected light intensity signal Pref (dBm) at the time of detecting the reflection abnormality in the reflection abnormality detection section, and calculates the reflected light intensity (=Pref−ΔP−α) when the reflection attenuation amount at the optical fiber open end is improved from the output light intensity lowering amount ΔP (dB) calculated with the output light intensity lowering function and the hysteresis amount setting signal α (dB) set in the hysteresis amount setting circuit 24 to output it as the recovery threshold.

The above process is equivalent to setting a value in which the output light intensity lowering amount and the hysteresis amount are subtracted from the reflected light intensity at the time of detecting the reflection abnormality to the recovery threshold.

The reflection abnormality recovery determination circuit 26 determines the presence or absence of reflection abnormality recovery by comparing the reflected light intensity outputted from the reflected light intensity monitor circuit 18 with the reflection abnormality recovery threshold calculated in the reflection abnormality recovery threshold calculation circuit 25, and notifies a result to the control circuit 27.

The control circuit 27 manages states of a reflection abnormality detection process, an output light intensity lowering process and a reflection abnormality recovery process, based on the results of the reflection abnormality detection determination circuit 22, the reflection abnormality recovery determination circuit 26 and the output light intensity lowering amount calculation circuit 23.

In the reflection abnormality detection process, the reflection abnormality detection threshold is calculated, and comparative determination with the monitored reflected light intensity is made, and the presence or absence of detecting the reflection abnormality is continuously monitored.

In the output light intensity lowering process, the output light intensity lowering amount is calculated after detecting the reflection abnormality, the control circuit 27 makes an instruction of the calculated output light intensity lowering amount ΔP, and the inter-apparatus communication circuit 35 passes the instruction to the wavelength multiplexing optical transmission apparatus 36 to lower the output light intensity.

In the reflection abnormality recovery process, the reflected light intensity is monitored, comparative determination with the reflection abnormality recovery threshold is made, and the presence or absence of the recovery from the reflection abnormality is continuously monitored. After determining the recovery from the reflection abnormality, the control circuit 27 makes an instruction of the output light intensity lowering amount ΔP=0 (dB), and the inter-apparatus communication circuit 35 passes the instruction to the wavelength multiplexing optical transmission apparatus 36 to return to the output light intensity at a required level.

In this embodiment, there are provided setting circuits for setting parameters of the reference light intensity, the reflection attenuation amount and the hysteresis amount which are required to calculate the reflection abnormality detection threshold, the output light intensity lowering amount and the reflection abnormality recovery threshold to the optimal values in accordance with the system specifications or the apparatus specifications. The setting circuits may be omitted, and the values may be fixedly set in each calculation circuit.

The control circuit has a role of monitoring and controlling each state of the reflection abnormality detection function, the output light intensity lowering function and the reflection abnormality recovery function.

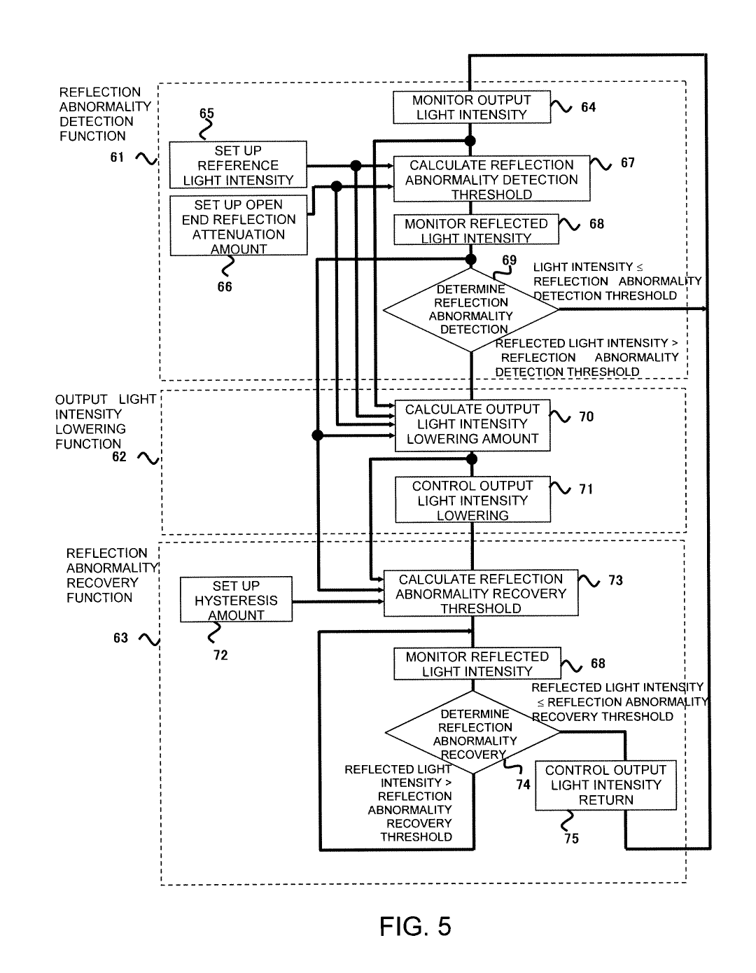

FIG. 5 is a flowchart showing one example of the cooperative operation of the reflection abnormality detection function, the output light intensity lowering function and the reflection abnormality recovery function under the monitor and control instructions of the control circuit.

In a reflection abnormality detection function block 61, the output light intensity is monitored (step 64), and the reflection abnormality detection threshold is calculated from the monitored output light intensity, the preset reference light intensity and the open end reflection attenuation amount (step 67). Comparative determination of the monitored reflected light intensity with the reflection abnormality detection threshold is made (steps 68 and 69). If the reflected light intensity is less than or equal to the detection threshold, the reflection abnormality is repeatedly monitored. If the reflected light intensity is greater than the detection threshold, the reflection abnormality is detected.

In an output light intensity lowering function block 62, the output light intensity lowering amount is calculated from the output light intensity, the reflected light intensity, the preset reference light intensity and the open end reflection attenuation amount (step 70), and output light intensity lowering control is performed (step 71). In an output light intensity lowering control block 71, the control unit instructs the signal light intensity control unit directly, or the wavelength multiplexing optical signal generation unit indirectly via notification unit to lower the output light intensity or the input light intensity by the calculated output light intensity lowering amount.

In a reflection abnormality recovery function block 63, the reflection abnormality recovery threshold is calculated from the output light intensity lowering amount, the reflected light intensity and the hysteresis amount in an output light intensity lowered state (step 73), and comparative determination of a newly monitored reflected light intensity with the reflection abnormality recovery threshold is made (steps 68 and 74). If the reflected light intensity is less than the recovery threshold, the recovery from the reflection abnormality is determined, and the output light intensity is controlled to return to the required level (step 75). In an output light intensity return control block 75, the control unit instructs the signal light intensity control unit directly, or the wavelength multiplexing optical signal generation unit indirectly via notification unit to return the output light intensity or the input light intensity to the required level so that the output light intensity lowering amount ΔP may be 0 (dB). Also, if the reflected light intensity is greater than the recovery threshold, the reflection abnormality recovery is repeatedly monitored.

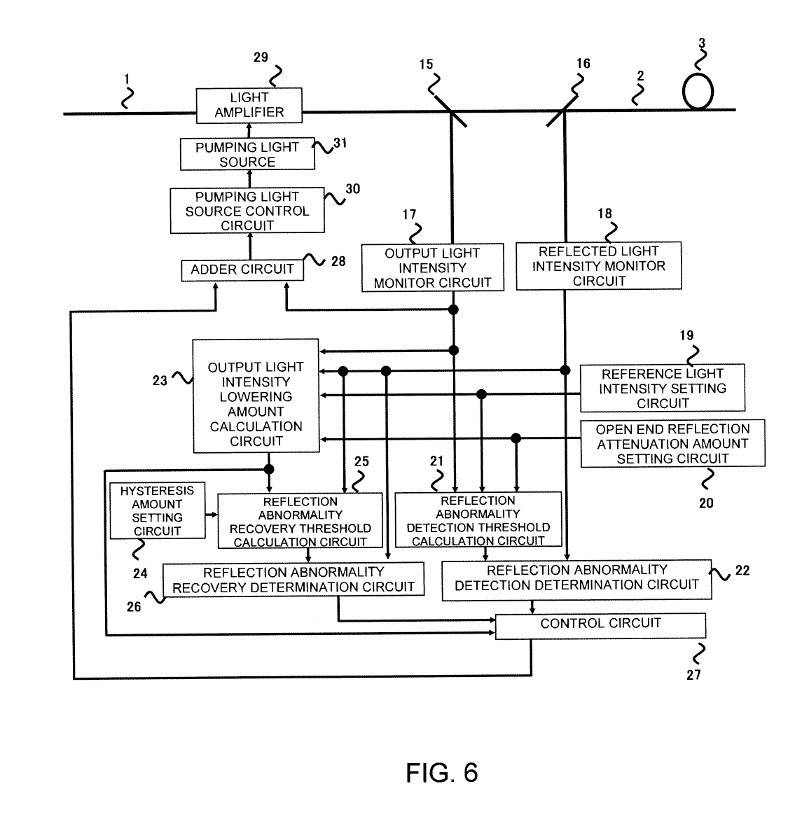

FIG. 6 shows a fourth configuration example of the optical repeater to fulfill the invention. FIG. 6 specifically shows a signal light intensity control unit.

The signal light intensity control unit has a pumping light source 31 for controlling the light intensity of the input optical signal with a light amplifier 29 and controlling a gain of the light amplifier 29, an adder circuit 28 for adding the output light intensity signal outputted from the output light intensity monitor circuit 17 and the output light intensity lowering amount signal outputted via the control circuit 27 from the output light intensity lowering amount calculation circuit 23, and a pumping light source control circuit 30 for controlling current of the pumping light source or a pumping light source output light intensity with the output signal of the adder circuit 28 as the input. For the light amplifier 29, a rare earth added fiber amplifier, for example, is applied. The other configuration is the same as the above optical repeater.

Taking an example where the output light intensity of the light amplifier is controlled to be a fixed value based on a signal proportional to the output light intensity inputted into the pumping light source control circuit 30, a unit for detecting the reflection abnormality in the reflection abnormality detection unit and lowering the output light intensity from the state where the output light intensity lowering amount is calculated will be described below.

The adder circuit 28 adds the output light intensity Pout outputted from the output light intensity monitor circuit 17 and the output light intensity lowering amount ΔP outputted from the output light intensity lowering amount calculation circuit 23, and outputs an apparent light intensity signal Pout+ (=Pout+ΔP) resulting from addition to the pumping light source control circuit 30. Since the pumping light source control circuit 30 controls the light amplifier output light intensity to be lowered by ΔP by adding the output light intensity lowering amount signal to the output light intensity signal actually outputted from the light amplifier 29 and apparently increasing the output light intensity signal inputted into the pumping light source control circuit 30, the output light intensity at the output point is lowered by ΔP.

In this configuration, a light amplification function is also provided, in which if no reflection abnormality is detected, with the output light intensity lowering amount ΔP=0 (dB), the gain of the light amplifier can be controlled to attain the required output light intensity as the light amplification function. This configuration is applicable to a light amplification repeater in the wavelength multiplexing optical transmission system.

The output light intensity monitor circuit can be shared between the light amplification function and the reflection abnormality detection function, and the lowering control and return control of the output light intensity can be implemented with the simple circuit configuration of adding the output light intensity lowering amount and the output of the output light intensity monitor circuit 17. Also, since the output light intensity control unit is provided, it is unnecessary to entrust an external apparatus to lower the output light intensity, and provide a unit for notifying the output light intensity lowering amount. This circuit configuration is simple, and suitable for the uses in which the output light intensity is lowered at high speed after detecting the reflection abnormality.

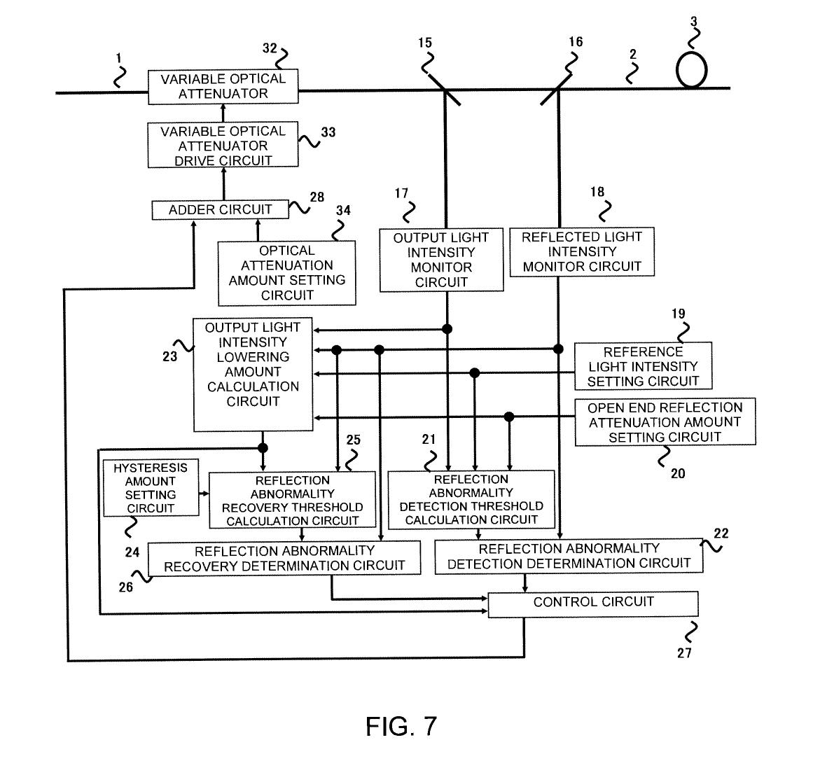

FIG. 7 shows a fifth configuration example of the optical repeater to fulfill the invention.

The signal light intensity control unit has an optical attenuation amount setting circuit 34 for setting the optical attenuation amount by controlling the light intensity of the input optical signal with a variable optical attenuator 32, the adder circuit 28 for adding an optical attenuation amount setting signal outputted from the optical attenuation amount setting circuit 34 and the output light intensity lowering amount signal outputted from the output light intensity lowering amount calculation circuit 23, and a variable optical attenuator drive circuit 33 for controlling the optical attenuation amount with the output signal of the adder circuit 28 as the input. The other configuration is the same as the above optical repeater.

Taking an example where the attenuation amount of the variable optical attenuator 32 is controlled based on a setting signal outputted from the optical attenuation amount setting circuit 34, a unit for detecting the reflection abnormality in the reflection abnormality detection unit and lowering the output light intensity from the state where the output light intensity lowering amount is calculated will be described below.

The adder circuit 28 adds an optical attenuation amount set amount (=ATT) outputted from the optical attenuation amount setting circuit 34 and the output light intensity lowering amount (ΔP) outputted from the output light intensity lowering amount calculation circuit 23, and inputs an addition result as a control target value of the optical attenuation amount (=ATT+ΔP) into the variable optical attenuator drive circuit 33. Since the optical attenuation amount of the variable optical attenuator 32 is increased by the output light intensity lowering amount (ΔP), the output light intensity at the output point is lowered by the output light intensity lowering amount (ΔP).

In this configuration, an optical attenuation function is also provided, in which if no reflection abnormality is detected, with the output light intensity lowering amount set as ΔP=0 (dB), the level adjustment can be made to attain the required output light intensity as the optical attenuation function. With the simple circuit configuration of adding the output light intensity lowering amount and the output of the optical attenuation amount setting circuit 34, the lowering control and return control of the output light intensity can be implemented. Also, since the output light intensity control unit is provided, it is unnecessary to entrust an external apparatus to lower the output light intensity, and provide a unit for notifying the output light intensity lowering amount. This circuit configuration is simple, and suitable for the uses in which the output light intensity is lowered at high speed after detecting the reflection abnormality.

With this embodiment, when the optical fiber end face is opened due to disconnecting of the optical fiber transmission line, the reflection abnormality can be detected, if the emitted light intensity at the optical fiber open end exceeds the reference light intensity stipulating the maximum value of the emitted light intensity, even though the open end position is arbitrary, or an optical component (e.g., optical filter or optical attenuator) that becomes the loss medium is inserted in the optical fiber transmission line. Also, even if the apparatus output light intensity is changed, the reflection abnormality detection threshold is recalculated from the apparatus output light intensity, and the optimal detection threshold can be set.

Also, if the reflection abnormality is detected, the apparatus output light intensity is lowered so that the open end emitted light intensity may not exceed the reference light intensity, in which the reflected light intensity at the time of determining the recovery is not too low, and the reflection attenuation amount at the open end required to recover from the reflection abnormality is the fixed amount, regardless of the open end position, so that the recovery determination can be made at the same level.

The invention is applicable to the optical transmission system, for example.

What is claimed is:

1. An optical repeater that sends an input optical signal to an optical fiber transmission line connected to an output port, the optical repeater comprising:
an output light intensity monitor unit for monitoring an output light intensity at an apparatus output point;
a reflected light intensity monitor unit for monitoring a reflected light intensity of a reflected light returning from the optical fiber transmission line to the apparatus output point;
a reflection abnormality detection threshold calculation unit for calculating, based on the output light intensity, a reflection abnormality detection threshold for detecting reflection abnormality due to disconnecting or opening of the optical fiber transmission line in a region where a light intensity of an open end emitted light emitted from an open end due to the disconnecting or the opening of the optical fiber transmission line is greater than a predetermined reference light intensity; and
a reflection abnormality detection determination unit for determining detection of the reflection abnormality by comparing the reflected light intensity with the reflection abnormality detection threshold.

2. An optical repeater that sends an input optical signal to an optical fiber transmission line connected to an output port by controlling a light intensity of the input optical signal, the optical repeater comprising:
an output light intensity monitor unit for monitoring an output light intensity at an apparatus output point;
a reflected light intensity monitor unit for monitoring a reflected light intensity of a reflected light returning from the optical fiber transmission line to the apparatus output point;
a reflection abnormality detection threshold calculation unit for calculating a reflection abnormality detection threshold, based on the output light intensity;
a reflection abnormality detection determination unit for determining detection of reflection abnormality due to disconnecting or opening of the optical fiber transmission line by comparing the reflected light intensity with the reflection abnormality detection threshold;
an output light intensity lowering amount calculation unit for calculating an output light intensity lowering amount based on an estimated emitted light intensity by estimating the emitted light intensity at an open end due to the disconnecting or the opening of the optical fiber transmission line based on the output light intensity and the reflected light intensity; and
a signal light intensity control unit for controlling the output light intensity to be sent to the optical fiber transmission line based on the output light intensity lowering amount calculated by the output light intensity lowering amount calculation unit.

3. An optical repeater that sends an input optical signal to an optical fiber transmission line connected to an output port by controlling a light intensity of the input optical signal, the optical repeater comprising:
an output light intensity monitor unit for monitoring an output light intensity at an apparatus output point;
a reflected light intensity monitor unit for monitoring a reflected light intensity of a reflected light returning from the optical fiber transmission line to the apparatus output point;
a reflection abnormality detection threshold calculation unit for calculating a reflection abnormality detection threshold, based on the output light intensity;
a reflection abnormality detection determination unit for determining detection of reflection abnormality due to disconnecting or opening of the optical fiber transmission line by comparing the reflected light intensity with the reflection abnormality detection threshold;
an output light intensity lowering amount calculation unit for calculating an output light intensity lowering amount based on the output light intensity and the reflected light intensity;
a signal light intensity control unit for controlling the output light intensity to be sent to the optical fiber transmission line based on the output light intensity lowering amount calculated by the output light intensity lowering amount calculation unit;
a reflection abnormality recovery threshold calculation unit for calculating a reflection abnormality recovery threshold, based on the output light intensity lowering amount and the reflected light intensity when the reflection abnormality is detected, or the reflected light intensity after controlling the output light intensity; and
a reflection abnormality recovery determination unit for determining recovery from the reflection abnormality by comparing the reflected light intensity with the reflection abnormality recovery threshold.

4. The optical repeater according to claim 1, wherein
the output light intensity monitor unit has
an output light branching optical coupler, inserted between an input port and the output port to which the optical fiber transmission line is connected, for causing an output light to branch to monitor the output light intensity, and
an output light intensity monitor circuit for inputting a signal light branched by the output light branching optical coupler and monitoring the output light intensity of the output port for sending to the optical fiber transmission line,
wherein the reflected light intensity monitor unit has
a reflected light monitor optical coupler for causing the reflected light to branch to monitor, the reflected light intensity returning from the optical fiber transmission line to the output port, and
a reflected light intensity monitor circuit for inputting the reflected light branched by the reflected light branching optical coupler and monitoring the reflected light intensity returning from the optical fiber transmission line to the output port.

5. The optical repeater according to claim 2, wherein
the output light intensity lowering amount calculation unit has
a reference light intensity setting circuit for setting a reference light intensity stipulating a permissible maximum value of light intensity emitted from the open end that is disconnected or opened, when the optical fiber transmission line is disconnected or opened,
a reflection attenuation amount setting circuit for setting a reflection attenuation amount due to Fresnel reflection at the open end, and
an output light intensity lowering amount calculation circuit for calculating the output light intensity lowering amount from an output signal of the output light intensity monitor unit, an output signal of the reflected light intensity monitor unit, a setting signal of the reference light intensity setting circuit, and a setting signal of the reflection attenuation amount setting circuit.

6. The optical repeater according to claim 3, wherein
the reflection abnormality recovery threshold calculation unit has
a hysteresis amount setting circuit for setting a hysteresis amount to provide a hysteresis characteristic in a reflection abnormality detection and recovery process, and
a reflection abnormality recovery threshold calculation circuit for calculating the reflection abnormality recovery threshold from an output signal of the reflected light intensity monitor unit, an output signal of the output light intensity lowering amount calculation unit and a setting signal of the hysteresis amount setting circuit.

7. The optical repeater according to claim 1, wherein the reflection abnormality detection threshold calculation unit
estimates an optical fiber transmission line loss from the apparatus output point to a virtual open end, at which the reference light intensity and the open end emitted light intensity are substantially equivalent, from the difference between the predetermined reference light intensity stipulating a permissible maximum value of the open end emitted light intensity emitted from the open end of the optical fiber transmission line and the output light intensity of the apparatus output point,
estimates a virtual reflected light intensity which is an intensity of assumed reflected light reflected at the virtual open end, attenuated by a reflection attenuation amount from the emitted light intensity at the virtual open end due to Fresnel reflection, returned to the apparatus output point with losing the estimated optical fiber transmission line loss, and observed by the reflected light intensity monitor unit, and
defines the virtual reflected light intensity as the reflection abnormality detection threshold.

8. The optical repeater according to claim 1, wherein the reflection abnormality detection threshold calculation unit calculates the reflection abnormality detection threshold Pdet, based on a predetermined reference light intensity Psafe (dBm) stipulating a permissible maximum value of the light intensity of the open end emitted light emitted from the open end of the optical fiber transmission line, monitored output light intensity Pout (dBm) at the apparatus output point, and a predetermined reflection attenuation amount R (dB) at the open end, by the following formula.
Pdet (dBm)=2×Psafe (dBm)−Pout (dBm)−R(dB) (1)

9. The optical repeater according to claim 2, wherein the output light intensity lowering amount calculation unit
estimates an optical fiber transmission line loss from the apparatus output point to the open end, based on the predetermined reflection attenuation amount at the open end and the difference between the output light intensity observed by the output light intensity monitor unit and reflected light intensity which is an intensity of reflected light attenuated by a reflection attenuation amount from the emitted light intensity due to Fresnel reflection at the open end where the optical fiber transmission line is disconnected or opened, returned to the apparatus output point, and observed by the reflected light intensity monitor unit,
estimates the emitted light intensity at the open end from the estimated optical fiber transmission line loss and the output light intensity, and
defines a value by which the estimated emitted light intensity at the open end exceeds the reference light intensity stipulating a permissible maximum value of the light intensity emitted from the open end as an apparatus output light intensity lowering amount.

10. The optical repeater according to claim 2, wherein the output light intensity lowering amount calculation unit calculates the output light intensity lowering amount ΔPout (dB), based on a predetermined reference light intensity Psafe (dBm) stipulating a permissible maximum value of a light intensity of an open end emitted light emitted from the open end of the optical fiber transmission line, the output light intensity Pout (dBm) at the apparatus output point, monitored reflected light intensity Pref (dBm), and a predetermined reflection attenuation amount R (dB) of the reflected light at the open end, by the following formula.
ΔPout (dB)=½×(Pout (dBm)+Pref(dBm)+R)−Psafe (2)

11. The optical repeater according to claim 3, wherein the reflection abnormality recovery threshold calculation unit defines a virtual reflected light intensity in which the output light intensity lowering amount and a predetermined hysteresis amount to provide a hysteresis characteristic in a reflection abnormality detection and recovery process are subtracted from the reflected light intensity at the time of detecting the reflection abnormality as the reflection abnormality recovery threshold.

12. The optical repeater according to claim 2, wherein
the signal light intensity control unit has
a light amplifier for controlling the light intensity of the input optical signal, so that an output light of the light amplifier may be a fixed value,
a pumping light source for controlling a gain of the light amplifier,
an adder circuit for adding an output light intensity signal outputted from the output light intensity monitor unit and an output light intensity lowering amount signal outputted from the output light intensity lowering amount calculation unit, and
a pumping light source control circuit for controlling current of the pumping light source or the output light intensity from the pumping light source, based on an output signal of the adder circuit.

13. The optical repeater according to claim 2, wherein
the signal light intensity control unit has
a variable optical attenuator for attenuating the input optical signal,
an optical attenuation amount setting circuit for setting an optical attenuation amount,
an adder circuit for adding the optical attenuation amount outputted from the optical attenuation amount setting circuit and the output light intensity lowering amount outputted from the output light intensity lowering amount calculation unit, and
a drive circuit for controlling the optical attenuation amount based on an output signal of the adder circuit.

14. An optical transmission apparatus comprising:
the optical repeater according to claim 1; and
an optical signal generation unit for generating an optical signal;
wherein the optical repeater inputs the optical signal from the optical signal generation unit.

15. A reflection abnormality detection method for detecting reflection abnormality of an optical signal in an optical fiber transmission line using an apparatus for sending the input optical signal to the optical fiber transmission line connected to an output port, comprising:
monitoring an output light intensity at an apparatus output point;
monitoring a reflected light intensity of a reflected light returning from the optical fiber transmission line to the apparatus output point;
calculating, based on the output light intensity, a reflection abnormality detection threshold for detecting the reflection abnormality due to disconnecting or opening of the optical fiber transmission line in a region where a light intensity of an open end emitted light emitted from an open end due to the disconnecting or the opening of the optical fiber transmission line is greater than a predetermined reference light intensity; and
determining detection of the reflection abnormality by comparing the reflected light intensity with the reflection abnormality detection threshold.

16. A reflection abnormality recovery determination method for determining recovery from reflection abnormality in an apparatus for sending an input optical signal to an optical fiber transmission line connected to an output port by controlling a light intensity of the input optical signal and detecting the reflection abnormality of the optical signal in the optical fiber transmission line, comprising:
monitoring an output light intensity at an apparatus output point;
monitoring a reflected light intensity of a reflected light returning from the optical fiber transmission line to the apparatus output point;
calculating an output light intensity lowering amount based on the output light intensity and the reflected light intensity, if the reflection abnormality of the reflected light is detected based on the output light intensity;
controlling the output light intensity to be sent to the optical fiber transmission line based on the output light intensity lowering amount;
calculating a reflection abnormality recovery threshold based on the output light intensity lowering amount and the reflected light intensity when the reflection abnormality is detected, or based on the reflected light intensity after controlling the output light intensity; and
determining recovery from the reflection abnormality by comparing the reflected light intensity with the reflection abnormality recovery threshold.
